(19) United States
(12) Patent Application Publication
(10) Pub. No.: US 2024/0259778 A1
(43) Pub. Date: Aug. 1, 2024

(54) MULTI-LINK SETUP OF A ROAMING NON-AP MLD

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/426,622

(22) Filed: Jan. 30, 2024

Related U.S. Application Data
(60) Provisional application No. 63/482,140, filed on Jan. 30, 2023.

(51) Int. Cl. H04W 8/14; H04W 76/15

(52) U.S. Cl. CPC H04W 8/14; H04W 76/15

(57) ABSTRACT

One example discloses a roaming AP (access point) MLD (multi-link device) for wireless communications, including: a first affiliated AP MLD and a second affiliated AP MLD; a controller configured to: establish a first set of links between the first affiliated AP MLD and a non-AP device at a first time; wherein each of the first set of links from the first affiliated AP MLD includes a first identifier in a frame transmission; identify the non-AP device as a roaming device when at a second time, a first link from the second affiliated AP MLD, having a second identifier in a frame transmission, is visible to the non-AP device, and a link having the first identifier in a frame transmission from the first affiliated AP MLD is no longer visible to the non-AP device; and establish a second set of links between the second affiliated AP MLD and the non-AP device at a third time, after a second link having the second identifier in a frame transmission from the second affiliated AP MLD is visible to the non-AP device.

### REFERENCE TO PROVISIONAL APPLICATION TO CLAIM PRIORITY

A priority date for this present U.S. patent application has been established by prior U.S. Provisional Patent Application, Ser. No. 63/482,140, entitled “Roaming AP MLD—Interface to DS and Broadcast”, filed on Jan. 30, 2023, and commonly assigned to NXP USA, Inc.

The present specification relates to systems, methods, apparatuses, devices, articles of manufacture and instructions for multi-link setup of a roaming non-AP MLD.

### SUMMARY

According to an example embodiment, a roaming AP (access point) MLD (multi-link device) for wireless communications, comprising: a first affiliated AP MLD and a second affiliated AP MLD; a controller configured to: establish a first set of links between the first affiliated AP MLD and a non-AP device at a first time; wherein each of the first set of links from the first affiliated AP MLD includes a first identifier in a frame transmission; identify the non-AP device as a roaming device when at a second time, a first link from the second affiliated AP MLD, having a second identifier in a frame transmission, is visible to the non-AP device, and a link having the first identifier in a frame transmission from the first affiliated AP MLD is no longer visible to the non-AP device; and establish a second set of links between the second affiliated AP MLD and the non-AP device at a third time, after a second link having the second identifier in a frame transmission from the second affiliated AP MLD is visible to the non-AP device.

In another example embodiment, the frame transmission is a group-addressed data frame; and the first affiliated AP MLD and the second affiliated AP MLD each owns a separate sequence number space for the group-addressed data frame.

In another example embodiment, the frame transmission is a group-addressed data frame; and the first affiliated AP MLD allocates a first sequence number to the group-addressed data frame for transmissions through a set of APs affiliated with the first affiliated AP MLD; and the second affiliated AP MLD allocates a second sequence number to the group-addressed data frame for transmissions through a set of APs affiliated with the second affiliated AP MLD.

In another example embodiment, the first identifier is same as the second identifier if the frame transmission is a group-addressed frame.

In another example embodiment, the first identifier and the second identifier are a same sequence number.

In another example embodiment, the first identifier is different from the second identifier if the frame transmission is another frame, different from the group-addressed frame.

In another example embodiment, the frame transmission is a group-addressed quality of service (QoS) data frame transmission.

In another example embodiment, at least one of the first identifier and the second identifier is at least one of: a GTK (Group Temporal Key), an Integrity Group Temporal Key (IGTK), or a Beacon Integrity Group Temporal Key (BIGTK).

In another example embodiment, a switch between the first set of links and the second set of links is in response to the non-AP device geographically roaming from a first location to a second location.

In another example embodiment, the non-AP device is an EHT non-AP device.

In another example embodiment, the non-AP device is an non-AP MLD; the establish the first set of links is a first multi-link setup for the non-AP MLD; the establish the second set of links is a second multi-link setup for the non-AP MLD; and a switch between the first multi-link setup and the second multi-link setup is in response to the non-AP MLD geographically roaming from a first location to a second location.

In another example embodiment, the non-AP device has a same association state with the first AP MLD as with the roaming AP MLD.

In another example embodiment, the roaming AP MLD is coupled to a distribution system (DS); the first AP MLD is serving the non-AP device; and a mapping between the non-AP device and the first AP device with which the non-AP device is associated, is not provided to the DS.

In another example embodiment, the first affiliated AP MLD has a different physical location than the second affiliated AP MLD.

In another example embodiment, the first set of links are established between the first AP MLD and the non-AP device when at the first time the non-AP device is in a first physical location; and the second set of links are established between the second AP MLD and the non-AP device when at the second time the non-AP device is in a second physical location.

In another example embodiment, the roaming AP MLD has a medium access control (MAC) service access point (SAP) address; and the first AP MLD and the second AP MLD have a same MAC SAP address as the roaming AP MLD.

In another example embodiment, the non-AP device is affiliated with a non-AP MLD.

In another example embodiment, one link of the roaming AP MLD carries an a Traffic indication map (TIM) indication of any buffered group-addressed frames of all other links of the roaming AP MLD.

In another example embodiment, one link of the first AP MLD carries a Traffic indication map (TIM) indication of any buffered group-addressed frames of all other links of the first AP MLD, and an indication of any buffered group-addressed frames of the links of the second AP MLD is not carried.

In another example embodiment, the roaming AP MLD corrects clock drift to be within a threshold between TSF timers of the first AP MLD and the second AP MLD.

In another example embodiment, the roaming AP MLD corrects clock drift based on TSF timers of any two AP devices affiliated with either the first AP MLD or the second AP MLD.

According to an example embodiment, a method for multi-link setup of a roaming non-AP MLD for wireless communications, comprising: establishing a first set of links between a first affiliated AP MLD and a non-AP device at a first time; wherein each of the first set of links from the first affiliated AP MLD includes a first identifier in a frame transmission; identifying the non-AP device as a roaming device when at a second time, a first link from a second affiliated AP MLD, having a second identifier in a frame transmission, is visible to the non-AP device, and a link having the first identifier in a frame transmission from the first affiliated AP MLD is no longer visible to the non-AP device; and establishing a second set of links between the second affiliated AP MLD and the non-AP device at a third time, after a second link having the second identifier in a frame transmission from the second affiliated AP MLD is visible to the non-AP device.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents a first example wireless local area network (WLAN) including an access point (AP) multi-link device (MLD) and a non-AP MLD (e.g. a client station (STA)).

FIG. 2 represents an example roaming operation of a non-AP MLD 11 within a second example WLAN.

FIG. 3 represents an example of reporting and reported links supporting the roaming operation of a non-AP MLD 11.

FIG. 4 represents an example set of AP MLDs visible to an EHT non-AP MLD 6 and an example set of AP MLDs visible to a UHR non-AP MLD 6 within the second example WLAN.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

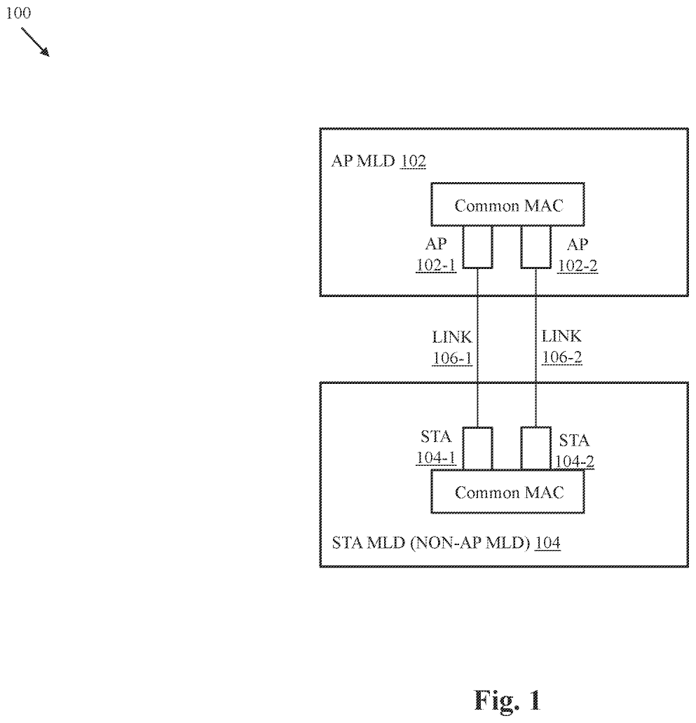

FIG. 1 represents an example wireless local area network (WLAN) 100 including an access point (AP) multi-link device (MLD) 102 and a non-AP MLD (e.g. a client station (STA)) 104. In some example embodiments, the WLAN 100 exchanges frames in accordance with an IEEE 802.11 protocol (e.g. 802.11be, 802.11ac very high throughput (VHT) protocol, 802.11ax high efficiency (HE) protocol, 802.11be extreme high throughput (EHT) protocol, 802.11bn ultra-high reliability (UHR) protocol, etc.).

In the example WLAN 100, in some example embodiments, the AP MLD 102 includes the upper layer Media Access Control (MAC) functionalities (e.g., association establishment, reordering of frames, etc.) and includes the APs 102-1 and 102-2 that implement lower layer MAC functionalities (e.g., backoff, frame transmission, frame reception, etc.). The 102-1 and 102-2 may be implemented in hardware (e.g., circuits), software, firmware, or a combination thereof. The APs 102-1 and 102-2 may be fully or partially implemented as an integrated circuit (IC) device.

In some example embodiments, the WLAN 100 is coupled to a backbone network (e.g., the Internet) through a wired connection and wirelessly connects to wireless STAs. In some example embodiments, an AP (e.g., AP1 102-1 and/or AP2 102-2) includes multiple RF chains. In some example embodiments, an AP (e.g., AP1 102-1 and/or AP2 102-2) includes at least one antenna, at least one transceiver operably connected to the at least one antenna, and at least one controller operably connected to the corresponding transceiver. In some example embodiments, at least one transceiver includes a physical layer (PHY) device. The at least one controller may be configured to control the at least one transceiver to process received packets through the at least one antenna.

In some example embodiments, the at least one controller may be implemented within a processor, such as a microcontroller, a host processor, a host, a digital signal processor (DSP), or a central processing unit (CPU), which can be integrated in a corresponding transceiver. In some example embodiments, each of the APs 102-1 and 102-2 of the AP MLD 102 with multiple RF chains may operate in different basic service set (BSS) operating channels (in different links). For example, AP1 102-1 may operate in a 320 MHz BSS operating channel at 6 GHz band, and AP2 102-2 may operate in a 160 MHz BSS operating channel at 5 GHz band.

The non-AP STA MLD 104 in this example WLAN 100 includes the common MAC that implement the MAC up layer functionalities (association, BA agreement establishment etc.) and two non-AP STAs 104-1 and 104-2 that implement the MAC lower layer functionalities (frame transmission, frame reception, backoff etc.). The STAs 104-1 and 104-2 may be implemented in hardware (e.g., circuits), software, firmware, or a combination thereof. The STAs 104-1 and 104-2 may be fully or partially implemented as an IC device. In some example embodiments, the STAs 104-1 and 104-2 are part of the STA MLD 104, such that the STA MLD may be a communications device that wirelessly connects to a wireless AP MLD. For example, the STA MLD 104 may be implemented in a laptop, a desktop personal computer (PC), a mobile phone, or other communications device that supports at least one WLAN communications protocol.

In some example embodiments, the AP MLD 102 and/or the STA MLD 104 may identify which communication links support multi-link operation during a multi-link operation setup phase and/or exchanges information regarding multi-link capabilities during the multi-link operation setup phase.

In some example embodiments, each of the non-AP STAs 104-1 and 104-2 of the STA MLD 104 may operate in different frequency bands. For example, the non-AP STA 104-1 in one link may operate in the 2.4 GHz frequency band and the non-AP STA 104-2 in another link may operate in the 5 GHz frequency band. In some example embodiments, each STA includes at least one antenna, at least one transceiver operably connected to the at least one antenna, and at least one controller connected to the corresponding transceiver. In some example embodiments, at least one transceiver includes a PHY device. The at least one controller may be configured to control the at least one transceiver to process received packets through the at least one antenna. In some example embodiments, the at least one controller may be implemented within a processor, such as a microcontroller, a host processor, a host, a DSP, or a CPU, which can be integrated in a corresponding transceiver.

In this example 100, the STA MLD 104 communicates with the AP MLD 102 via two communication links 106-1 and 106-2. The communication links (e.g., link 106-1 or link 106-2) may include a BSS operating channel established by an AP (e.g., AP 102-1 or AP 102-2) that features multiple 20 MHz channels used to transmit frames (e.g., Beacon frames, management frames, etc.) being carried in Physical Layer Convergence Protocol (PLCP) Protocol Data Units (PPDUs) between a first wireless device (e.g., an AP, an AP MLD, an STA, or an STA MLD) and a second wireless device (e.g., an AP, an AP MLD, an STA, or an STA MLD).

In some example embodiments, a 20 MHz channel may be a punctured 20 MHz channel or an unpunctured 20 MHz channel.

As described above a multi-link AP MLD has one or multiple links where each link has one AP affiliated with the AP MLD. This may be accomplished by having the different radios for the different affiliated APs. A multi-link STA MLD has one or multiple links where each link has one STA affiliated with the STA MLD. One way to implement the multi-link STA MLD is using two or more radios, where each radio is associated with a specific link. For example, a multi-link multi-radio (MLMR) non-AP MLD may be used. The MLMR non-AP MLD uses multiple full functional radios to monitor the medium in multiple links. Another way to implement the multi-link STA MLD is using a single radio in two different bands. Each band may be associated with a specific link. In this case, only one link is available at a time.

In yet another implementation, an enhanced single-radio (ESR) STA MLD may be used that operates in an enhanced multi-link single radio (eMLSR) mode. The ESR STA MLD uses two radios in different bands or the same band to implement the MLD. For example, one radio may be a lower cost radio with lesser capabilities and the other radio may be a fully functional radio supporting the latest protocols. The ESR STA MLD may dynamically switch its working link while it can only transmit or receive through one link at any time. The ESR STA MLD may monitor two links simultaneously, for example, detecting medium idle/busy status of each link, or receiving a PPDU on each link.

Each radio may have its own backoff procedure, and when the backoff counter for one of the radios becomes zero, that radio and link may be used for transmission. For example, if an AP wants to use the fully functional radio, it may send a control frame that is long enough for the ESR STA MLD to switch from the lesser capable radio to the fully functional radio that may then transmit data to the AP.

When an extended service set (ESS) includes multiple AP MLDs in different locations and a STA MLD executed the data frame exchanges with one of the AP MLDs (e.g., AP MLD1), as the STA MLD moves/roams to another location to do the data frame exchanges with another one of the affiliated AP MLDs (say AP MLD2), the STA MLD (same as a non-AP MLD herein) needs to finish the association (e.g. handoff) with AP MLD2 before doing the data frame exchanges with AP MLD2.

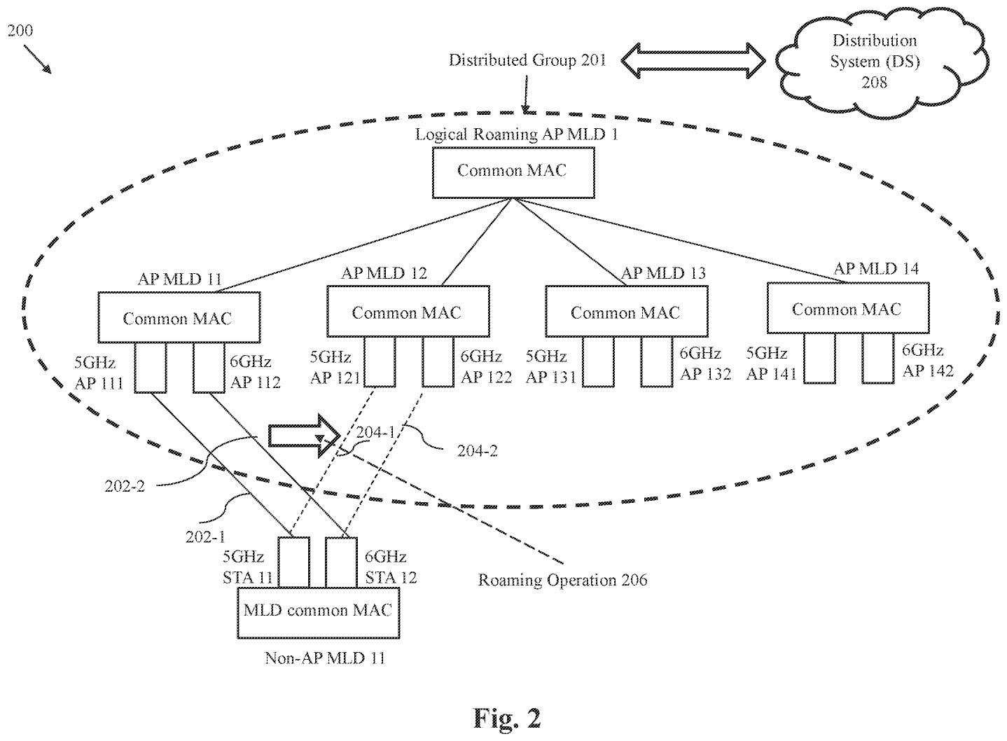

FIG. 2 represents an example roaming operation 206 of a non-AP MLD 11 that roams within a second example WLAN 200. A logical roaming AP MLD 1 includes a number of different affiliated AP MLDs 11, 12, 13, 14, which are in substantially different physical/geographic locations. Together they operate as a distribution group 201 (e.g. mobility domain) having a common MAC service access point (SAP) address (e.g. “Common MAC” shown in FIG. 2).

Note, the roaming AP MLD 1 is a logical MLD that itself is NOT actually “moving”, but is affiliated with the other MLDs 11, 12, 13, 14 which are typically at “different geographical locations”. Typically only the non-AP MLD 11 (e.g. a vehicle or person's smartphone) is “moving” between the “different geographical locations” but a hitless/seamless handoff experience is provided to the non-AP MLD 11 using the “Common MAC” address.

Seamless (i.e. hitless) roaming is a type of wireless roaming that allows a non-AP device (e.g. a mobile device) to switch between different AP devices without interrupting frame exchanges with the non-AP device. This means the non-AP device can maintain a continuous connection to a roaming AP MLD, a distribution system (DS), an ESS, a network, etc. while physically moving, without the need for additional association. In one embodiment, a non-AP MLD has one serving AP MLD for its frame exchanges when the non-AP MLD doesn't do the roaming or finishes it roaming. In another embodiment, a non-AP MLD can have multiple serving AP MLDs for its frame exchanges when the non-AP MLD doesn't do the roaming or finishes it roaming. For a non-AP MLD, the roaming AP may be a logical entity that exists in the current serving AP MLD of a non-AP MLD.

In one embodiment, each AP MLD 11, 12, 13, 14 has its own unique ID (identifier) in the distributed (e.g. logical roaming) AP MLD group 201. These unique IDs each have a different ID space. In another embodiment, each AP MLD 11, 12, 13, 14 is identified by their unique MAC SAP address (AP MLD address). In other words, each AP MLD in a roaming AP MLD is identified by its MAC SAP address, which means that the additional ID is not needed.

In this example 200, the AP MLD 11 includes 5 GHz AP 111 and 6 Ghz AP 112. The AP MLD 12 includes 5 GHz AP 121 and 6 Ghz AP 122. The AP MLD 13 includes 5 GHz AP 131 and 6 Ghz AP 132. The AP MLD 14 includes 5 GHz AP 141 and 6 Ghz AP 142.

The non-AP MLD 11 that includes 5 GHz STA 11 and 6 GHz STA 12, is shown as having already established a multi-link association with the logical roaming AP MLD 1 through AP MLD 11 (e.g. a serving AP MLD). There are two setup links 202-1 and 202-2 between AP MLD 11 and the non-AP MLD 11. The link 202-1 is between the 5 GHz AP 111 and the 5 GHz STA 11. The link 202-2 is between the 6 Ghz AP 112 and the 6 GHz STA 12. Thus, the non-AP MLD 11 can execute data frame exchanges with the serving AP MLD 11 affiliated with the logical roaming AP MLD 1.

The non-AP MLD 11 in many example embodiments is mobile and can physically move relative to the logical roaming AP MLD 1. Therefore, the non-AP MLD 11 may roam from one AP MLD11 (i.e. a current serving AP MLD) affiliated with the AP MLD 1 to another AP MLD 12 (i.e. future serving AP MLD) affiliated with the logical roaming AP MLD 1 without a need for reassociation and PMK/PTK renegotiation (i.e. hitless/seamless roaming).

Through the roaming operation 206 for the non-AP MLD 11 establishes new setup links 204-1 and 204-2 between the AP MLD 12 and non-AP MLD 11, and a frame exchange context of the non-AP MLD 11 is transferred from the prior serving AP MLD 11 to the new serving AP MLD 12 for future frame exchanges. The new link 204-1 is between the 5 GHz AP 121 and the 5 GHz STA 11, and the new link 204-2 is between the 6 Ghz AP 122 and the 6 GHz STA 12. In such example embodiment, except the roaming stage, the non-AP MLD 11 will always have one serving AP MLD to do the frame exchanges for class 3 frames allowed by the state after the association and authentication for key establishment (state 4 in 802.11).

In some example embodiments a distribution system (DS) 208 connects APs into an ESS (Extended Service Set). An ESS can include any combination of one or more logical roaming AP MLDs, one or more AP MLDs and one or more APs. Thus in some example embodiments more than one logical roaming AP MLDs can exist in a single ESS.

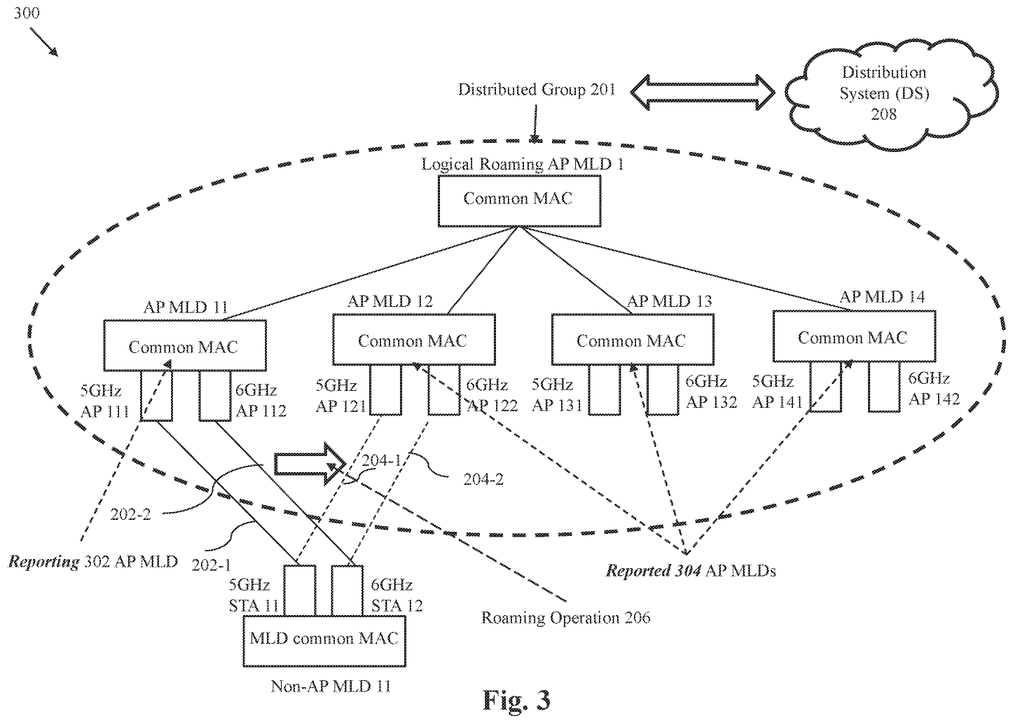

FIG. 3 represents an example 300 of reporting 302 and reported 304 links supporting the roaming operation 206 of the non-AP MLD 11. The reporting link is the link where a management frame is transmitted and the reported link is a link (say link2) whose information is carried in a management frame that is transmitted in a different link (say link1 as the reporting link).

Since the non-AP MLD 11 is currently in communication with the logical roaming AP MLD 1 via AP MLD 11 in the distributed group 201, prior to switching to a new serving AP MLD through the roaming operation 206 of the roaming non-AP MLD, AP MLD 11 is labeled as a reporting 302 AP MLD where one of its affiliated AP will be used to transmit the management frame with the roaming information and the other AP MLDs 12, 13, 14 are labeled as reported 304 AP MLDs where their information will be transmitted by the management frame of the reporting AP MLD.

In various example embodiments, when the non-AP MLD 11 switches (i.e. roams) from one AP MLD (a.k.a. the current serving 210 AP MLD) affiliated with the logical roaming AP MLD 1 to another AP MLD (a.k.a. the new serving 212 AP MLD) affiliated with the same roaming AP MLD 1, a link addresses of the new serving 212 AP MLD is carried in a protected roaming action frame.

When a non-AP MLD roams from one AP MLD (e.g. the current serving 210 AP MLD) affiliated with a logical roaming AP MLD to another AP MLD (e.g. the new serving 212 AP MLD) affiliated with the same logical roaming AP MLD, there is no need for a new association since the non-AP MLD made an association with the logical roaming AP MLD when the non-AP MLD establishes a multi-link connection with an AP MLD affiliated with the logical roaming AP MLD. When a non-AP MLD roams from one AP MLD (e.g. the current serving 210 AP MLD) affiliated with a logical roaming AP MLD to another AP MLD (e.g. the new serving 212 AP MLD) affiliated with the same logical roaming AP MLD, there is no need for a new PMK and PTK since the non-AP MLD made PMK and PTK negotiation with the logical roaming AP MLD when the non-AP MLD establishes a multi-link connection with an AP MLD affiliated with the logical roaming AP MLD.

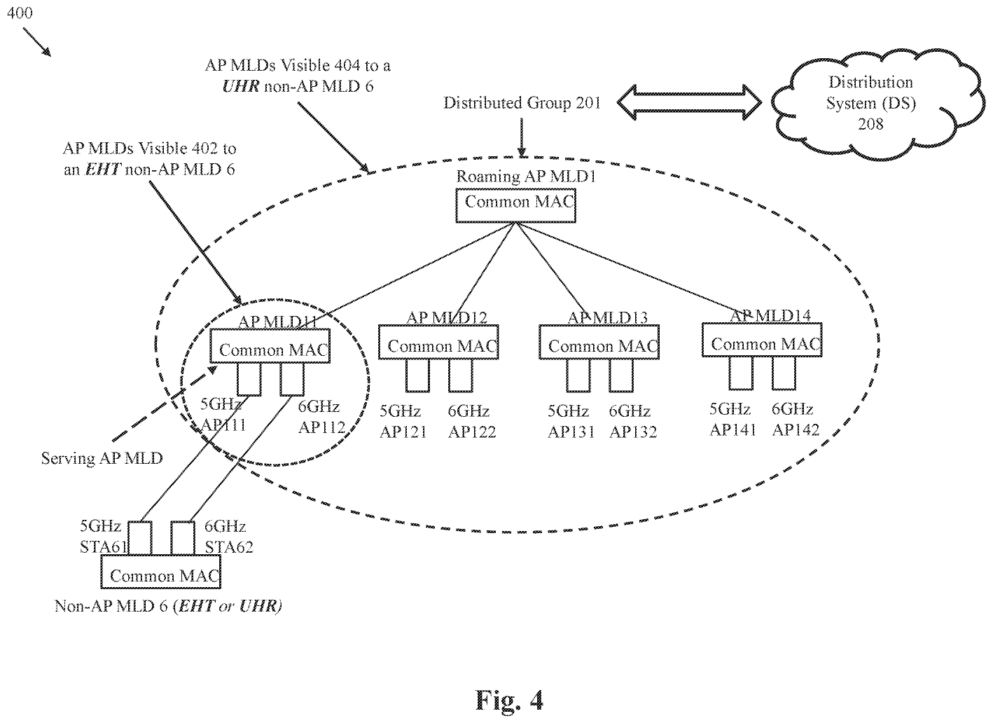

FIG. 4 represents an example 400 of a set of AP MLDs visible 402 to an EHT non-AP MLD 6 and a set of AP MLDs visible 404 to a UHR non-AP MLD 6 within the second example WLAN 200.

In this example 400, only the AP MLD (e.g. AP MLD 11) affiliated with the logical roaming AP MLD 1 is visible 402 to an EHT protocol non-AP MLD 6. Thus the logical roaming AP MLD 1 would not be visible to an EHT non-AP MLD 6.

However, for a UHR non-AP MLD 6, besides the AP MLD11, 12,13,14, the logical roaming AP MLD 1 is also visible to the UHR non-AP MLD 6.

Since a UHR non-AP MLD has visibility to the entire distributed group 201 (i.e. the logical roaming MLD 1), the UHR non-AP MLD can use the common MAC SAP address of the logical roaming AP MLD 1 as its interface to the Distribution System (DS) and any further ESS.

Due to the UHR's visibility 504, a multi-link setup (i.e. association) and PMK/PTK negotiation of a roaming UHR non-AP MLD 6 can be done with the roaming AP MLD, and seamlessly roam among the AP MLDs 11, 12, 13, 14 in the roaming AP MLD 1 distributed group 201 without the reassociation and key renegotiation.

Multi-link setup of a roaming EHT non-AP MLD 6 however is more complicated and is now discussed below

A group-addressed frame is transmitted by each AP affiliated with an AP MLD. An AP MLD allocate the sequence numbers (SNs) of the group-addressed Data frames in a SN space. In other words, a group-addressed Data frame being transmitted by each AP affiliated with the AP MLD has the same sequence number. The single SN space for group-addressed Data frames can help a non-AP MLD to avoid the duplicated submission of a group-addressed Data frame to the MAC up layer when the non-AP MLD uses its multiple setup links to receive the group-addressed Data frames.

A roaming AP MLD may have multiple AP MLDs affiliated with it, e.g. within a second example WLAN 200, a logical roaming AP MLD 1 includes a number of different affiliated AP MLDs 11, 12, 13, 14. Multiple UHR non-AP MLDs associated with the roaming AP MLD through various AP MLDs affiliated with the roaming AP MLD. There is a requirement to decide whether the sequence number of a group-addressed Data frame is allocated by the roaming AP MLD or allocated separately by each AP MLD affiliated with one roaming AP MLD.

In some of these example embodiments, the roaming AP MLD in distributed group 201 can own the sequence number space for group-addressed Data frames transmitted by any of the AP MLDs affiliated with the roaming AP MLD. In other words, the roaming AP MLD allocate the sequence number to each group-addressed Data frame for the affiliated AP MLDs to transmit through their affiliated APs. For a group-addressed Data frame, all the APs (AP111, AP112, AP121, AP 122, AP131, AP132, AP141, AP142 in distributed group 201 as an example) affiliated with the AP MLDs (AP MLD 11, AP MLD 12, AP MLD13, AP MLD 14) that affiliated with the roaming AP MLD (roaming AP MLD 1) will have a same sequence number when the broadcast Data frame is broadcasted in each of their links owned by the roaming AP MLD.

In other of these example embodiments, each AP MLD affiliated with the roaming AP MLD 1 in distributed group 201 can own the sequence number space for group-addressed Data frames transmitted by the AP MLD affiliated with the roaming AP MLD. In other words, Each AP MLD affiliated with the roaming AP MLD 1 allocates the sequence number to each group-addressed Data frame for the AP MLD to transmit through its affiliated APs. For a group-addressed Data frame, AP111, AP112 affiliated with the AP MLD 11 will have a same sequence number when the broadcast Data frame is broadcasted in each of AP MLD11's links. However for the group-addressed Data frame, AP121, AP122 affiliated with the AP MLD 12 will have another same sequence number when the broadcast Data frame is broadcasted in each of AP MLD12's links.

In an example embodiments, each link of an AP-MLD affiliated with a roaming AP MLD has its own GTK, IGTK, BIGTK.

A GTK (Group Temporal Key), IGTK, BIGTK are notified by the AP affiliated with an AP MLD to a STA affiliated with a non-AP MLD during the 4-Way Authentication Handshake between the AP MLD and the non-AP MLD or during the smooth roaming to the AP MLD. The GTK is used to encrypt/decrypt multicast and broadcast Data traffic frames. The Integrity Group Temporal Key (IGTK) is used to encrypt/decrypt multicast and broadcast Robust Management Frames. The Beacon Integrity Group Temporal Key (BIGTK) is used to protect Beacon frames from that AP.

In some example embodiments, in order to implement the above example embodiments, modifications to Traffic indication map (TIM) element and/or Clock Drift elements may be needed.

For example, a Traffic indication map (TIM) element of one link of an AP MLD carries the indication of the buffered group-addressed frames of all the other links of the same AP MLD. Currently the TIM is a bitmap, including an Association ID (AID) of each non-AP STA, to indicate to any sleeping listening stations that an associated AP has buffered data waiting for it. Because stations should listen to at least one beacon during the listen interval, the AP periodically sends this bitmap in its beacons as an information element.

For example, one link of a roaming AP MLD 1 carries a Traffic indication map (TIM) indication of any buffered group-addressed frames of all other links of the roaming AP MLD.

In another example, one link of an AP MLD affiliated with a roaming AP MLD carries an indication of the buffered group-addressed frames of all the other links of the AP MLD, and the indication of the buffered group-addressed frames of the links of the other AP MLDs affiliated with the roaming AP MLD are not carried.

Regarding clock drift, currently an AP MLD corrects the clock drift to be within ±30 μs between TSF timers of any two APs affiliated with it.

In some examples, a roaming AP MLD can now correct the clock drift to be within a threshold (e.g. ±30 μs) between TSF timers of any two APs affiliated with it. The roaming AP MLD can also correct clock drifts among its affiliated AP MLDs, using the mechanism(s) of TSN time sync protocol(s) within a threshold (e.g. +/−30 us).

In other examples, an AP MLD affiliated with the roaming AP MLD can correct the clock drift to be within ±30 μs between TSF timers of any two APs affiliated with the AP MLD. The two APs of the two AP MLDs affiliated with the roaming AP MLD will not correct the clock drift between their TSF timers.

Various example sets of instructions for enabling multi-link setup of a roaming EHT non-AP MLD based on the material discussed in this specification. An order in which the material discussed in this specification has been discussed does not limit an ordering of such instructions unless otherwise specifically stated. Additionally, in some example embodiments the instructions could be implemented in parallel.

Various systems, such as the example second example WLAN 200 just discussed, can host these instructions. Such systems can include an input/output data interface, a processor, a storage device, and a non-transitory machine-readable storage medium. The machine-readable storage medium includes the instructions which control how the processor receives input data and transforms the input data into output data, using data within the storage device. The machine-readable storage medium in an alternate example embodiment is a non-transitory computer-readable storage medium. In other example embodiments the set of instructions described above can be implemented either using logic gates, application specific chips, firmware, as well as other hardware forms.

In some example embodiments the set of instructions described above are implemented as functional and software instructions. In other embodiments, the instructions can be implemented either using logic gates, application specific chips, firmware, as well as other hardware forms.

When the instructions are embodied as a set of executable instructions in a non-transitory computer-readable or computer-usable media which are effected on a computer or machine programmed with and controlled by said executable instructions. Said instructions are loaded for execution on a processor (such as one or more CPUs). Said processor includes microprocessors, microcontrollers, processor modules or subsystems (including one or more microprocessors or microcontrollers), or other control or computing devices. A processor can refer to a single component or to plural components. Said computer-readable or computer-usable storage medium or media is (are) considered to be part of an article (or article of manufacture). An article or article of manufacture can refer to any manufactured single component or multiple components. The non-transitory machine or computer-usable media or mediums as defined herein excludes signals, but such media or mediums may be capable of receiving and processing information from signals and/or other transitory mediums.

Example embodiments of the material discussed in this specification can be implemented in whole or in part through network, computer, or data based devices and/or services. These may include cloud, internet, intranet, mobile, desktop, processor, look-up table, microcontroller, consumer equipment, infrastructure, or other enabling devices and services. As may be used herein and in the claims, the following non-exclusive definitions are provided.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may but do not necessarily, all refer to the same embodiment.

What is claimed is:

1. A roaming AP (access point) MLD (multi-link device) for wireless communications, comprising:
a first affiliated AP MLD and a second affiliated AP MLD;
a controller configured to:
establish a first set of links between the first affiliated AP MLD and a non-AP device at a first time;
wherein each of the first set of links from the first affiliated AP MLD includes a first identifier in a frame transmission;
identify the non-AP device as a roaming device when at a second time,
a first link from the second affiliated AP MLD, having a second identifier in a frame transmission, is visible to the non-AP device, and
a link having the first identifier in a frame transmission from the first affiliated AP MLD is no longer visible to the non-AP device; and
establish a second set of links between the second affiliated AP MLD and the non-AP device at a third time, after a second link having the second identifier in a frame transmission from the second affiliated AP MLD is visible to the non-AP device.

2. The roaming AP MLD of claim 1:
wherein the frame transmission is a group-addressed data frame; and
wherein the first affiliated AP MLD and the second affiliated AP MLD each owns a separate sequence number space for the group-addressed data frame.

3. The roaming AP MLD of claim 1:
wherein the frame transmission is a group-addressed data frame; and
wherein the first affiliated AP MLD allocates a first sequence number to the group-addressed data frame for transmissions through a set of APs affiliated with the first affiliated AP MLD; and
wherein the second affiliated AP MLD allocates a second sequence number to the group-addressed data frame for transmissions through a set of APs affiliated with the second affiliated AP MLD.

4. The roaming AP MLD of claim 1:
wherein the first identifier is same as the second identifier if the frame transmission is a group-addressed frame.

5. The roaming AP MLD of claim 4:
wherein the first identifier and the second identifier are a same sequence number.

6. The roaming AP MLD of claim 4:
wherein the first identifier is different from the second identifier if the frame transmission is another frame, different from the group-addressed frame.

7. The roaming AP MLD of claim 1:
wherein the frame transmission is a group-addressed quality of service (QoS) data frame transmission.

8. The roaming AP MLD of claim 1:
wherein at least one of the first identifier and the second identifier is at least one of: a GTK (Group Temporal Key), an Integrity Group Temporal Key (IGTK), or a Beacon Integrity Group Temporal Key (BIGTK).

9. The roaming AP MLD of claim 1:
wherein a switch between the first set of links and the second set of links is in response to the non-AP device geographically roaming from a first location to a second location.

10. The roaming AP MLD of claim 1:
wherein the non-AP device is an EHT non-AP device.

11. The roaming AP MLD of claim 1:
wherein the non-AP device is an non-AP MLD;
wherein the establish the first set of links is a first multi-link setup for the non-AP MLD;
wherein the establish the second set of links is a second multi-link setup for the non-AP MLD; and
wherein a switch between the first multi-link setup and the second multi-link setup is in response to the non-AP MLD geographically roaming from a first location to a second location.

12. The roaming AP MLD of claim 1:
wherein the non-AP device has a same association state with the first AP MLD as with the roaming AP MLD.

13. The roaming AP MLD of claim 1:
wherein the roaming AP MLD is coupled to a distribution system (DS);
wherein the first AP MLD is serving the non-AP device; and
wherein a mapping between the non-AP device and the first AP device with which the non-AP device is associated, is not provided to the DS.

14. The roaming AP MLD of claim 1:
wherein the first affiliated AP MLD has a different physical location than the second affiliated AP MLD.

15. The roaming AP MLD of claim 1:
wherein the first set of links are established between the first AP MLD and the non-AP device when at the first time the non-AP device is in a first physical location; and
wherein the second set of links are established between the second AP MLD and the non-AP device when at the second time the non-AP device is in a second physical location.

16. The roaming AP MLD of claim 1:
wherein the roaming AP MLD has a medium access control (MAC) service access point (SAP) address; and
wherein the first AP MLD and the second AP MLD have a same MAC SAP address as the roaming AP MLD.

17. The roaming AP MLD of claim 1:
wherein the non-AP device is affiliated with a non-AP MLD.

18. The roaming AP MLD of claim 1:
wherein one link of the roaming AP MLD carries an a Traffic indication map (TIM) indication of any buffered group-addressed frames of all other links of the roaming AP MLD.

19. The roaming AP MLD of claim 1:
wherein one link of the first AP MLD carries a Traffic indication map (TIM) indication of any buffered group-addressed frames of all other links of the first AP MLD, and an indication of any buffered group-addressed frames of the links of the second AP MLD is not carried.

20. The roaming AP MLD of claim 1:
wherein the roaming AP MLD corrects clock drift to be within a threshold between TSF timers of the first AP MLD and the second AP MLD.

21. The roaming AP MLD of claim 1:
wherein the roaming AP MLD corrects clock drift based on TSF timers of any two AP devices affiliated with either the first AP MLD or the second AP MLD.

22. A method for multi-link setup of a roaming non-AP MLD for wireless communications, comprising:
establishing a first set of links between a first affiliated AP MLD and a non-AP device at a first time;
wherein each of the first set of links from the first affiliated AP MLD includes a first identifier in a frame transmission;
identifying the non-AP device as a roaming device when at a second time,
a first link from a second affiliated AP MLD, having a second identifier in a frame transmission, is visible to the non-AP device, and
a link having the first identifier in a frame transmission from the first affiliated AP MLD is no longer visible to the non-AP device; and
establishing a second set of links between the second affiliated AP MLD and the non-AP device at a third time, after a second link having the second identifier in a frame transmission from the second affiliated AP MLD is visible to the non-AP device.
